(19) United States
(12) Patent Application Publication
(10) Pub. No.: US 2022/0286336 A1
(43) Pub. Date: Sep. 8, 2022

(54) IMPROVED OFDM RANGING USING POSITION REFERENCE SYMBOL PHASE

(71) Applicant: iPosi, Inc., Denver, CO (US)

(72) Inventors: RICHARD M. LEE, Denver, CO (US); CHRISTOPHER NEIL KURBY, Denver, CO (US)

(21) Appl. No.: 17/637,303

(22) PCT Filed: Aug. 24, 2020
(86) PCT No.: PCT/US20/47628

§ 371 Date: Feb. 22, 2022

Related U.S. Application Data
(60) Provisional application No. 62/890,972, filed on Aug. 23, 2019.

(51) Int. Cl. H04L 27/26

(52) U.S. Cl. CPC H04L 27/261; H04L 27/2663; H04L 27/2665

(57) ABSTRACT

Improved approaches for use of RF signals (e.g., OFDM signals) for determining a range that can be used for geolocation of a device. The disclosure includes systems and methods that may allow for transition from a correlation approach to a group delay approach. In addition, upon detection of the presence of multipath error in a signal, a signal bandwidth may be increased to as to include additional position reference symbols (PRS) that are included in a determination of a propagation delay, and in turn, a range. In addition, use of a different number of symbols in a signal based on signal SNR is presented.

### CROSS REFERENCE TO RELATED APPLICATIONS

This application is a U.S. National Phase of PCT Application No. PCT/US2020/047628 filed on Aug. 24, 2020, titled “IMPROVED OFDM RANGING USING POSITION REFERENCE SYMBOL PHASE”, which claims the benefit of provisional application No. U.S. 62/890,972, filed on Aug. 23, 2020, titled “IMPROVED OFDM RANGING USING POSITION REFERENCE SYMBOL PHASE”, the entirety of which has been incorporated herein by reference.

### BACKGROUND

Use of radiofrequency (RF) signals for geolocation of communications devices is common. Various systems exist that utilize RF signals for geolocation including system that use GNSS signals, Long-Term Evolution (LTE) fourth generation (4G) of broadband cellular network technology (4G LTE or 5G), OFDAM WiFi or other appropriate RF signals. For instance, mobile communications systems and protocols such as the 4G LTE specification provide specific protocols that may be used to assist in determining a range between a transmitter in such a system and a device in such a system (sometimes referred to as user equipment (UE)). Such systems may utilize orthogonal frequency division multiplexing (OFDM) or orthogonal frequency division multiple access (OFDMA) signals for communication of data and/or for use in location determination. Determining ranges between a plurality of transmitters and a device may allow for multilateration techniques (e.g., trilateration) to be applied for geolocation of the device relative to known locations of the transmitters.

While such approaches to geolocation of devices using RF signals such as 4G LTE signals is common place, certain aspects of the system are constrained by limitations that include limited resolution of the determined geolocation solution, susceptibility to error due to multipath signal propagation, and limitations in relation to correction of clock resolution time errors. In turn, further advancements in technology related to use of RF signals, and OFDM signals in particular, are needed to overcome the current limitations and further improve such location determination approaches.

### SUMMARY

The present disclosure generally relates to ranging using OFDM signals. Specifically, the present invention facilitates improvements in methods employed to calculate a range such that accuracy of such ranges may be improved, and ranging is less susceptible to errors introduced by multipath signal errors.

A first example method includes ranging using orthogonal frequency division multiplexed (OFDM) signals. The method includes receiving a first OFDM signal at a receiver at a first bandwidth and measuring a signal power of each of a plurality of symbols of subcarriers for the first OFDM signal. The method also includes determining a signal anomaly in the first OFDM signal based on the signal power of each of the plurality of symbols in the first OFDM signal. In turn, the method includes increasing the first bandwidth to a second bandwidth and receiving a second OFDM signal at the second bandwidth. The method also includes calculating a range from a transmitter of the second OFDM signal to the receiver based on the second OFDM signal at the second bandwidth.

A second example method for ranging using orthogonal frequency division multiplexed (OFDM) signals includes receiving at a receiver a first OFDM signal having a first signal to noise ratio (SNR) and determining a first number of reference symbols to use to determine a first range between a transmitter of the first OFDM signal and the receiver. The method includes receiving at the receiver a second OFDM signal having a second SNR that is greater than the first SNR and determining a second number of reference symbols to use to determine a second range between a transmitter of the second OFDM signal and the receiver. Specifically, the second number of reference symbols is greater than the first number of reference symbols.

A third example method includes ranging using orthogonal frequency division multiplexed (OFDM) signals. The method includes first receiving a first OFDM signal having at least one positioning reference signal (PRS) and determining a coarse time reference using an observed time difference of arrival (OTDOA) correlation applied to the first OFDM signal. The method also includes second receiving a second OFDM signal having a plurality of positioning reference signals and determining a phase slope of the plurality of positioning reference signals (PRSs) based on the coarse time reference. The method also includes calculating a fine time reference having an accuracy greater than the coarse time reference using the phase slope of the plurality of PRSs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 is a schematic of an example LTE OFDM signal including position reference symbols.

FIG. 2 is an example plot of OFDM signal strength versus OFDM frequency in a signal without multipath propagation error.

FIG. 3 is an example plot of OFDM signal phase relative to OFDM frequency for use in determining a signal delay from the slope of the plotted signal phase.

FIG. 4 is an example plot illustrating a relationship between time error and range error in a group delay approach to OFDM signal ranging.

FIG. 5 is an example plot of OFDM signal strength versus OFDM frequency in the presence of a multipath signal with a longer propagation path in the OFDM signal.

FIG. 6 is an example plot of OFDM signal phase difference relative to adjacent OFDM frequency for a signal not having multipath and a signal having multipath

FIG. 7 is an example plot of OFDM signal phase relative to OFDM frequency having two signals, one of which does not have multipath and one which does include multipath and, consequently, phase error.

FIG. 8 is an example schematic of a system for use in determining a range between a transmitter and a receiver using OFDM signals according to the present disclosure.

FIG. 9 includes example operations for operation of a system according to the present disclosure.

FIG. 10 is an example schematic of a system for use in determining a range between a transmitter and a receiver using OFDM signals according to the present disclosure.

FIG. 11 illustrates two example plots illustrating additional PRS symbols being available in response to increasing a bandwidth of an OFDM signal.

FIG. 12 illustrates plots of symbol phase versus frequency for a number of OFDM signals.

FIG. 13 illustrates plots of error values for various signal bandwidths in the presence of the same multipath propagation error.

FIG. 14 illustrates plots of error values for various signals in the presence of various levels of multipath propagation error for various receiver bandwidths.

FIG. 15 illustrates a plot of delay value errors relative to various signal to noise ratios (SNR) and signal bandwidths.

FIG. 16 illustrates error relative to SNR for a number of signals in which different numbers of the symbols of each signal are used as PRS elements for determining a range.

FIG. 17 error relative to SNR for a number of signals in which different numbers of the symbols of each signal are used as PRS elements for determining a range with threshold values for switching between approaches to minimize error.

FIG. 18 illustrates an example schematic of a processing device suitable for implementing aspects of the disclosed technology.

### DETAILED DESCRIPTIONS

This disclosure relates to approaches and/or enhancements related to the use of RF signals such as OFDM/4G LTE signals to calculate a range between a transmitter and a device receiving the RF signals from the transmitter. As will be described in greater detail below, the 4G LTE specification generally provides an approach to ranging using a signal correlation approach for a signal having a position reference symbol (PRS). This correlation approach has been supplemented with a group delay approach in which the phase difference between a plurality of PRSs may be measured and correlated to a delay of propagation of the signal containing the PRSs. The present disclosure provides an approach in which a transition from the correlation to the group delay approach may be used. Furthermore, the present disclosure provides an approach in which multipath error in a signal may be identified and, in response, bandwidth of the received signal may be increased to mitigate the error of the multipath signal. Additionally, the present disclosure provides an approach in which the number of symbols used in the determination of range may be modified based on threshold SNR values for the signals.

RF signals (e.g., OFDM signals such as 4G LTE signals) may be used to determine the time of flight from an LTE transmitter to an LTE receiver. This is typically done using the cross correlation of one or more transmitted position reference symbol (PRS). PRSs include PRS elements with a known PRS pattern. However, this correlation approach may result in a limitation of time accuracy to the resolution of the receiver sampling clock as seen in the table below.

TABLE 1
LTE Band Configurations

| | | | | | | | | |
|---|---|---|---|---|---|---|---|---|
| Channel Bandwidth [MHz] | 0.18 | 0.18 | 1.4 | 3 | 5 | 10 | 15 | 20 |
| Number of resource blocks (N_RB) | 1 | 1 | 6 | 15 | 25 | 50 | 75 | 100 |
| Number of occupied subcarriers | 12 | 12 | 72 | 180 | 300 | 600 | 900 | 1200 |
| Actual BW of subcarriers used | 0.18 | 0.18 | 1.08 | 2.7 | 4.5 | 9 | 13.5 | 18 |
| IDFT(Tx)/DFT(Rx) size | 16 | 128 | 128 | 256 | 512 | 1024 | 1536 | 2048 |
| Sample rate [MHz] | 0.24 | 1.92 | 1.92 | 3.84 | 7.68 | 15.36 | 23.04 | 30.72 |
| Samples per slot | | | 960 | 1920 | 3840 | 7680 | 11520 | 15360 |
| PRS | 2 | 2 | 12 | 30 | 50 | 100 | 150 | 200 |

Approaches that use a group delay based on PRSs have been proposed in U.S. Pat. No. 9,261,576, the entirety of which is incorporated by reference. The group delay is calculated by the phase slope of the symbol elements. However this approach has several limitations in that 1) there are only 6 PRS elements in 180 KHz, thus limiting performance, 2) in the presence of multipath the system is degraded, and 3) this approach only provides a correction to clock resolution time error.

With further explanation of the use of OFDM/LTE signals for ranging, OFDM can be considered as a transmission of a set of subcarriers over a channel bandwidth. In a 4G LTE signal 10 MHz channel, only 9 MHz is actually occupied by subcarriers. When pilot symbols are transmitted, these subcarriers are represented as known tones with a known phase. The slope of the phase over the subcarriers represents a time delay and can be calculated directly from the slope as

$$delay = - \frac{d ( ϕ )}{d ( w )} .$$

If the phase response is not linear which is a constant group delay then a regression or linear curve fit to calculate m (delay) in the equation delay=−mw+k is used.

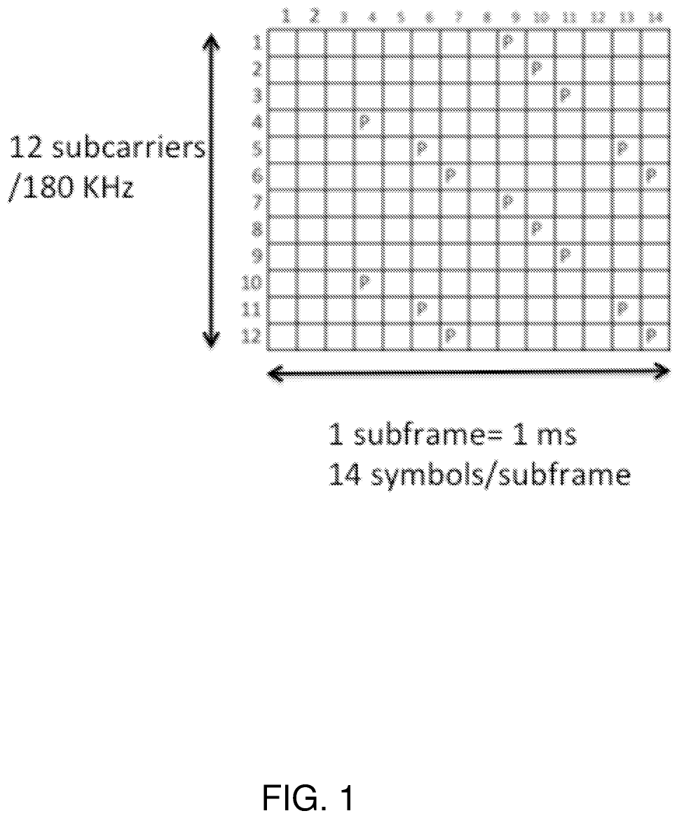

In 4G LTE, the subcarriers are spaced 15 KHz apart and have a symbol duration of 66.6 microseconds. In the case of LTE the pilots symbols are called Primary Reference Symbols (PRS) and are spaced 6 subcarriers or 90 KHz apart. This is repeated over the channel and is illustrated in FIG. 1.

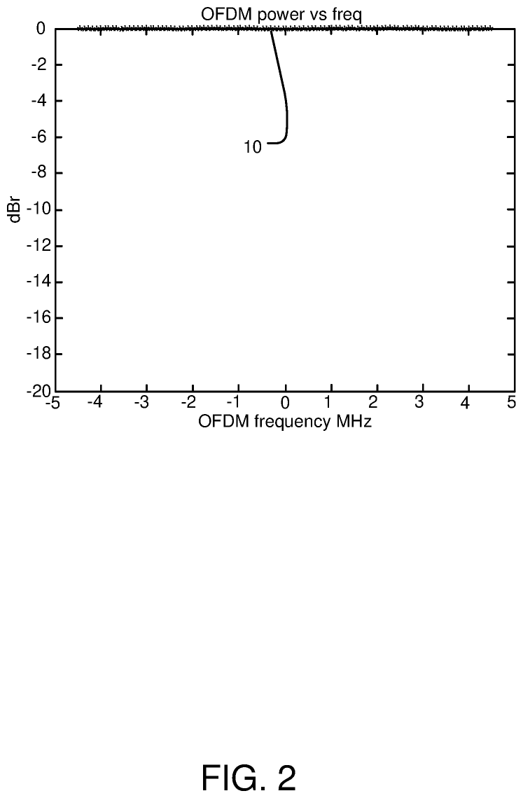

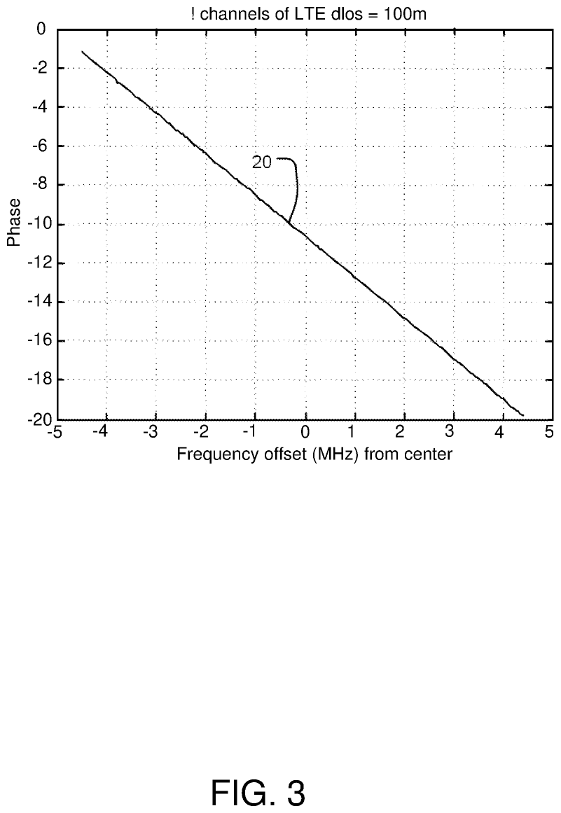

In turn, for an OFDM signal received at a receiver, the amplitude of the signal may be plotted against frequency as shown in FIG. 2. Specifically, FIG. 2 is a plot of amplitude versus frequency for PRS pilot signals in a 10 MHz channel. As can be seen the amplitude 10 is flat across the subcarriers in the absence of multipath (MP) signal propagation. Also, the OFDM signal may be plotted with phase relative to the frequency offset from center for the OFDM signal as shown in FIG. 3. In FIG. 3, the phase slope of the plot 20 provides a fixed delay value that can be expressed as

$$delay = - \frac{d ( ϕ )}{d ( w )} .$$

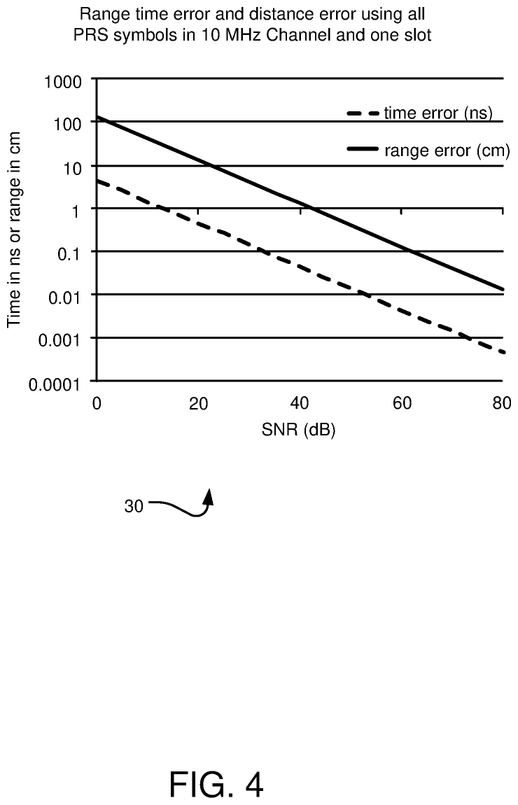

As the phase slope of the plot 20 is linear, the fixed delay value is constant across the 15 kHz sub carriers. A simulation may be conducted for a range error or delay as described in delay value equation above as a function of signal to noise ratio or SNR. The plot 30 shown in FIG. 4 gives the performance for a 10 MHz channel over one symbol time using all the PRS symbols. This illustrates the value of the method for ranging signals.

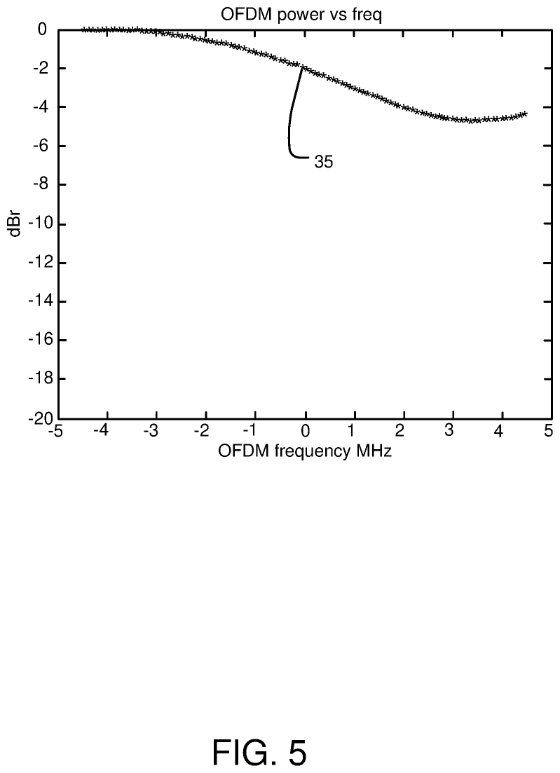

However, as described above, this approach for determining a delay, and therefore range value between a transmitter and receiver may be susceptible to error in scenarios where MP signal propagation occurs. As such, a simulated MP signal may be added to a simulation with the MP signal −10 dB in signal strength from the line of sight (LOS) signal and a total path distance difference of 20 m. This would mean that means the LOS path is 100 m and the MP length is 120 m. FIG. 5 shows the power of each signal across the PRS OFDM subcarriers in the channel (of which there are 100 in the 9 MHz occupied bandwidth). FIG. 5 shows that the amplitude 35 of a MP signal is not flat across the received subcarriers in the presence of MP and can be used to detect that MP is present. The flatness is defined as the difference between the highest OFDM signal power (dB) and the lowest OFDM signal power (dB).

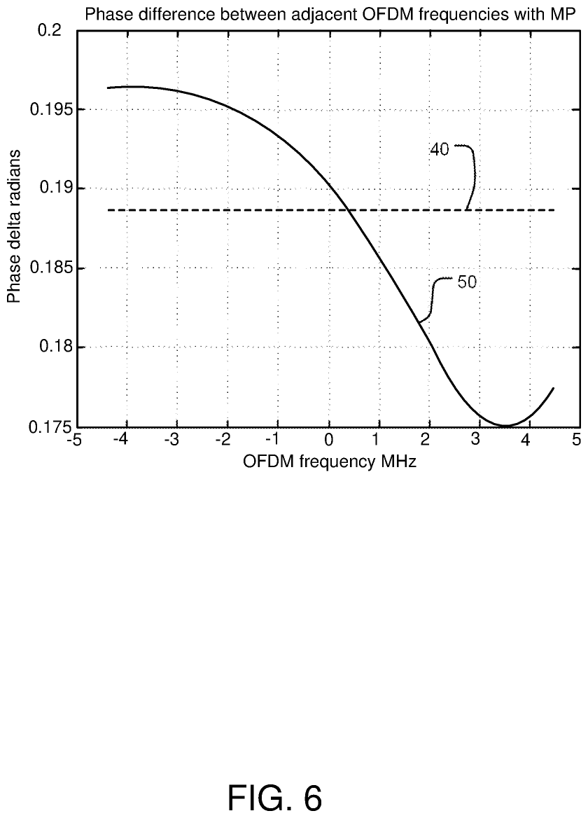

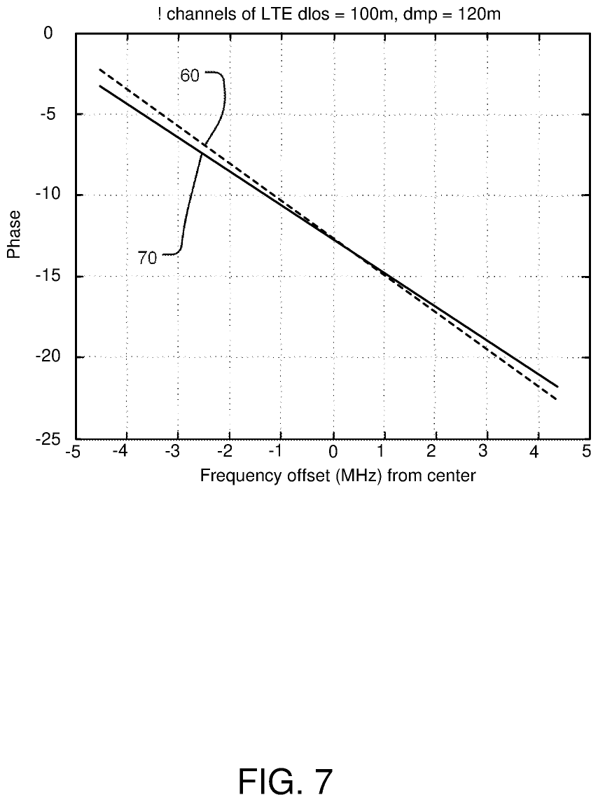

FIG. 6 represents the plotted phase response of such a MP signal. Plot line 40 represents a LOS signal and plot line 50 represents a MP signal. FIG. 6 clearly shows that the phase response is not linear and MP error is clearly present. MP does not always manifest as a clear nonlinear phase response. FIG. 7 shows such a case, in which plot line 60 represents a LOS signal and plot line 70 represents a MP signal. Both plot line 60 and 70 are very linear and the impact of MP error cannot readily be determined from the phase response alone. As such, the presence of MP may be detected either by the deviation of flatness of the spectrum or the non-linearity of the phase plot. As will be discussed in greater detail below, steps can be taken to compensate once MP error is detected.

A further limitation on existing ranging approaches using the PRS correlation method relates to limitations in relation to sampling ambiguity in view of the symbol period. For instance, use of the PRS correlation approach or any other like symbol or frame time based on sample resolution will have a time error due to the ambiguity of the sample time with respect to the actual received symbol time. For example a receiver sample clock of 15.36 MHz for a 4G LTE bandwidth of 10 MHz as seen in Table 1 above has a time ambiguity of +/−½ the sample time or

$$\frac{- 1}{2 * 15.36 e 6} < Tamb < \frac{1}{2 * 15.36 e 6} .$$

When multiplied by the speed of light, this is +/−9.75 meter error window to which these methods are subject. The use of the group delay accounts for the resolution time error as it is a direct calculation of group delay and not dependent on sample time. Thus very low time and distance errors can be obtained providing the SNR of the OFDM signal is great enough. Moreover even if the sample rate is decimated to a lower rate the accuracy can be maintained.

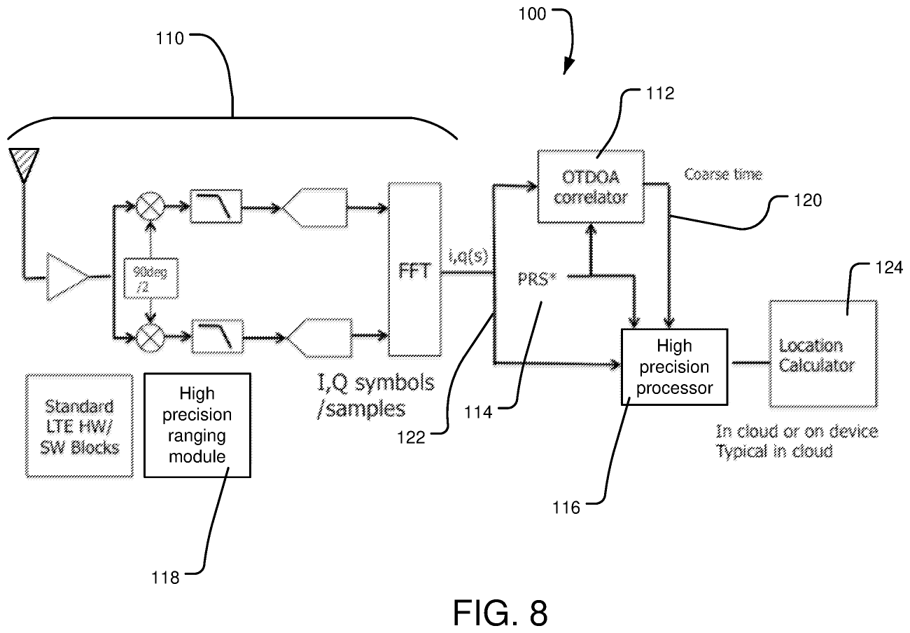

Accordingly, with reference to FIG. 8 a system 100 is shown that may be used to transition from a correlation method to a group delay method. The system 100 may include a processing portion 110 that may be used to receive an OFDM signal and process the OFDM signal. This processing may include analog to digital conversion and use of a fast Fourier transform to provide the OFDM signal in the frequency domain i.e. signal per subcarrier. The output of the fast Fourier transform may include information on symbol phase for modulated symbols in the OFDM signal.

In turn, the system 100 may include a correlator module 112. The correlator module 112 may receive a PRS correlation signal 114. The PRS correlation signal 114 may be calculated to produce a replica PRS signal from the OFDM signal or may be based on almanac information regarding the PRS elements of the OFDM signal (e.g., as published in 4G LTE specifications). In any regard, the correlator module 112 may perform a cross correlation between the received OFDM signal as output from the processing portion 110 and the PRS correlation signal 114. The result of the correlation performed by the correlator module 112 may be a coarse time 120 provided to a high precision processor 116.

The high precision processor 116 is electrically coupled to a high precision ranging module 118 stored in a memory of the system 100. The high precision ranging module 118 may provide machine readable instructions that configure the high precision processor 116 to perform a group delay analysis as described above to determine a signal delay based on a determined slope of the symbol phases of the OFDM signal. Specifically, the high precision processor 116 may receive the coarse time 120, the PRS correlation signal 114, and the OFDM signal 122 to perform the group delay approach. Upon determining the delay value, the high precision processor 116 may pass the information to a location calculator 124 that be used to calculate the location of the system 100. For instance, the location calculator 124 may receive three or more range values or delays from the high precision processor 116 to perform trilateration for determining the location. The location calculator 124 may be local to the system 100 or remote. In the latter regard, the system 100 may communicate with the location calculator 124 via network communication.

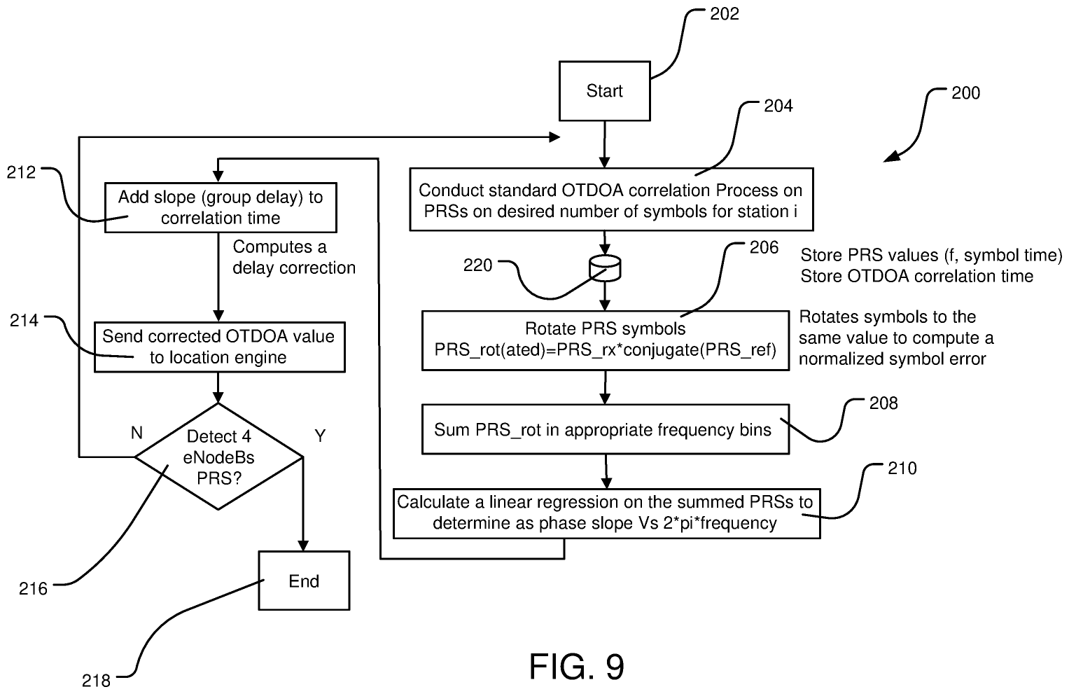

Accordingly, a correlation approach (e.g., OTDOA) may be used in a first time period to first get a coarse time using the correlation process, then once that is achieved the group delay method described above that utilizes the phase slope may be used to refine the time and range. Such an approach is shown in FIG. 9, which depicts example operations 200. The operations may commence at start operation 202. A conducting operation 204 conducts a standard correlation process on PRS symbols in the OFDM signal. The PRS values and the coarse time generated by the correlation approach may be stored in a data store 220. A rotating operation 206 rotates symbols to the same value to compute a normalized symbol error. A summing operation 208 sums the PRS rotations from appropriate frequency bins. In turn, a calculating operation 210 calculates a linear regression on the summed PRSs to determine a phase slope according to the group delay approach. An adding operation 212 adds the calculated slope (e.g., the group delay value) to the coarse time generated by the conducting operation 204. In turn, the delay correction added to the coarse time may be sent to a location calculator in a sending operation 214. A determination operation 216 determines if signals from four transmitters have been processed. If not, the operations iterate and the operations return to the conducting operation 204. If four signals from respective transmitters have been received, the operations 200 terminate at the end operation 218.

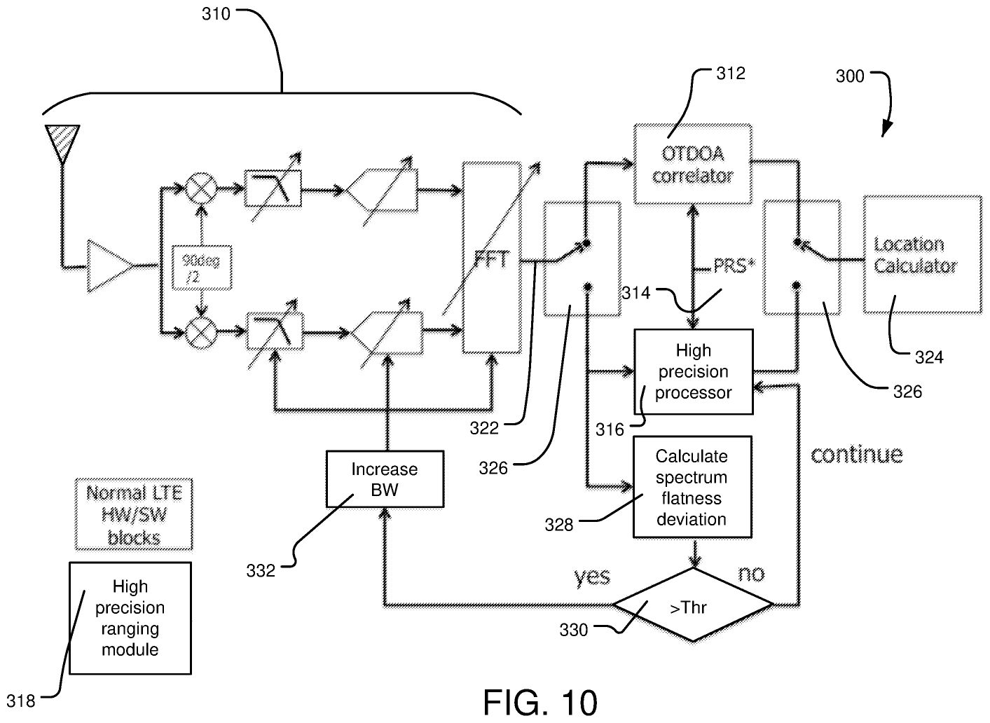

Furthermore, when using the group delay approach that includes calculation of the phase slope, the system 100 may monitor for the presence of MP signals as described above. Once MP error is detected based on any approach described above, the bandwidth of the OFDM signal is increased to intercept more OFDM PRS subcarriers. Such a system is shown in FIG. 10.

With reference to FIG. 10 a system 300 is shown that may be used in determining a range using an OFDM signal. The system 300 includes a processing portion 310 that may be used to receive, digitize, and perform a fast Fourier transform on the OFDM signal such that the OFDM signal 322 is output from the processing portion 310 in a form suitable for digital processing. A correlator module 312 is provided that may receive the OFDM signal 322 and a PRS correlation signal 314 to perform a correlation approach as described above. In at least a first time period, the correlation module 312 may provide a delay value (e.g., which can be transformed to a range by multiplication by the speed of light) to a location calculator 324.

The system 310 further includes processing approach selectors 326. The processing approach selectors 326 may be used to switch the processing of the signal 322 from the correlation approach to a group delay approach using a high precision processor 316. The high precision processor 316 is electrically coupled to a high precision ranging module 318 stored in a memory of the system 300. The high precision processor 318 may provide machine readable instructions that configure the high precision processor 316 to perform a group delay analysis as described above to determine a signal delay based on a determined slope of the symbol phases of the OFDM signal.

Additionally, a MP detection module 328 may monitor the OFDM signal 322 to determine the presence of MP error using one of the approaches described above. For instance, the MP detection module 328 may monitor the flatness of the amplitude of the OFDM signal 322 relative to the frequency to determine a value quantifying the flatness of the power as described above. If the flatness is less than a flatness threshold (e.g., indicating sufficiently low MP error) at a comparator 330, the high precision processor 316 may continue operation without change. However, if the comparator 330 determines the flatness threshold is exceeded, a signal is provided to a bandwidth modification module 332, which may increase the bandwidth of the OFDM signal 322. By increasing the bandwidth of the OFDM signal 322 in response to detection of MP error, additional PRS elements may be provided to counteract the MP error included in the signal 322.

In one example, a value of about 5 dB may be an appropriate flatness threshold value for a 9 MHz bandwidth. Once a deviation in flatness of the plotted signal power relative to OFDM frequency exceeds the threshold value of flatness, the system may switch to a wider bandwidth such as 36 MHz or 4 10 MHz channels. Note that the subcarriers in 4 bands do not have to be contiguous on a 15 KHz basis; the guard band between the 10 MHz channels (9 MHz occupied) is acceptable.

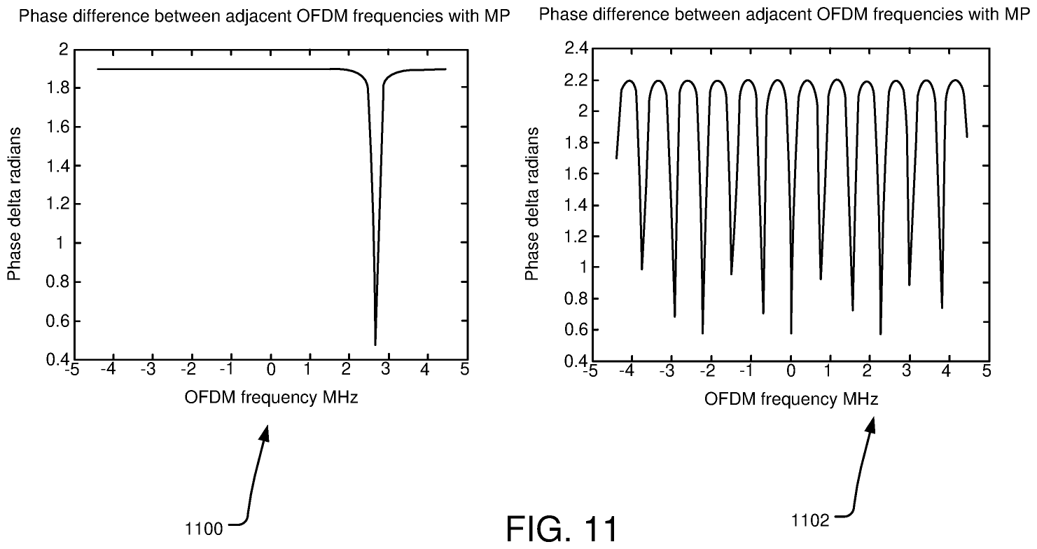

As such, in the present disclosure, upon detection of MP error in an OFDM signal, the bandwidth may be increased. One specific approach includes averaging of many subcarriers, which has the same effect as increasing to a single signal of higher bandwidth, but is easier to implement. FIG. 11 illustrates how many phase cycles are averaged versus differential distance (i.e., the distance of the LOS signal and the distance of the MP signal). The plot 1100 on the left represents a line of sight distance of 1000 m and a multipath distance of 1010 m. The plot 1102 on the right represents a line of sight distance of 1000 m and a multipath distance of 1400 m.

The differential distance of 400 m has 13 phase cycles versus 1 phase cycle for the 10 m case. This is equivalent to increasing the channel BW from 10 MHz to 400 MHz (corresponding to an occupied BW from 9 to 360 MHz).

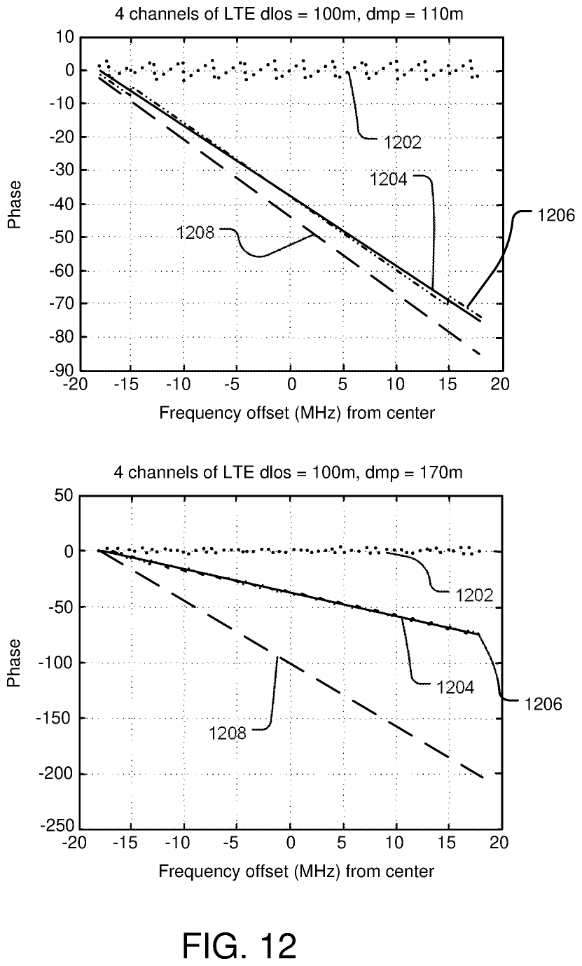

As second way to view the effectiveness of this approach is to look at the phase of the different signal formations as seen in FIG. 12. Traces 1202 are the multipath phase before unwrapping. The traces 1204 are the multipath phases after unwrapping, the traces 1206 are the unwrapped phase of the LOS signal+MP, and the traces 1208 the linear regression fit which overlaps the LOS signal. The traces 1206 shows that the unwrapped MP signal cycles around the LOS signal, such that the more cycles it rotates the lower the error. Thus increasing the bandwidth increases the number of rotations and reduces the number of fractional cycles, which are responsible for the range error.

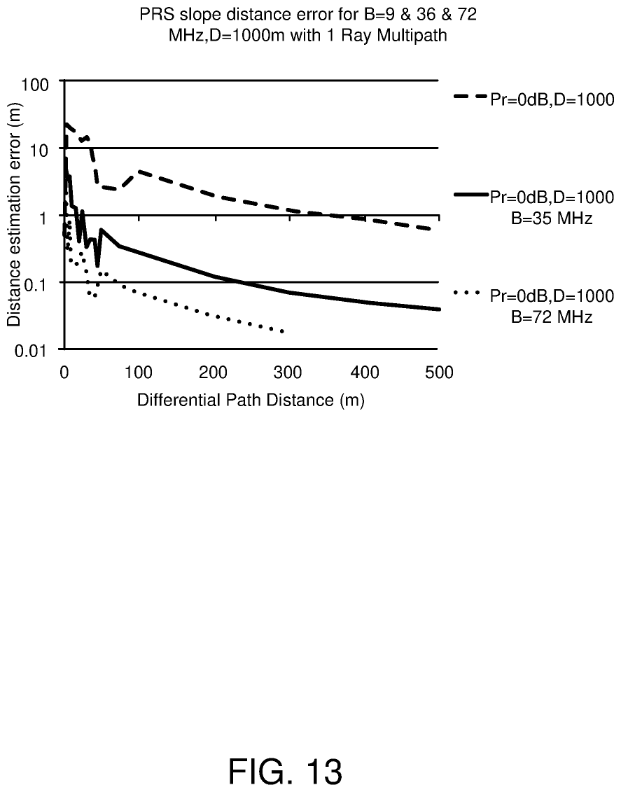

The range error may be calculated for occupied bandwidths of 9 MHz, 36 MHz and 72 MHz, and the results are shown in FIG. 13. The plot in FIG. 13 illustrates that with increasing bandwidth the range error is reduced. Again, as the differential path length increases the amount of phase rotations around the LOS signal increases leaving less fractional phase to create the range error.

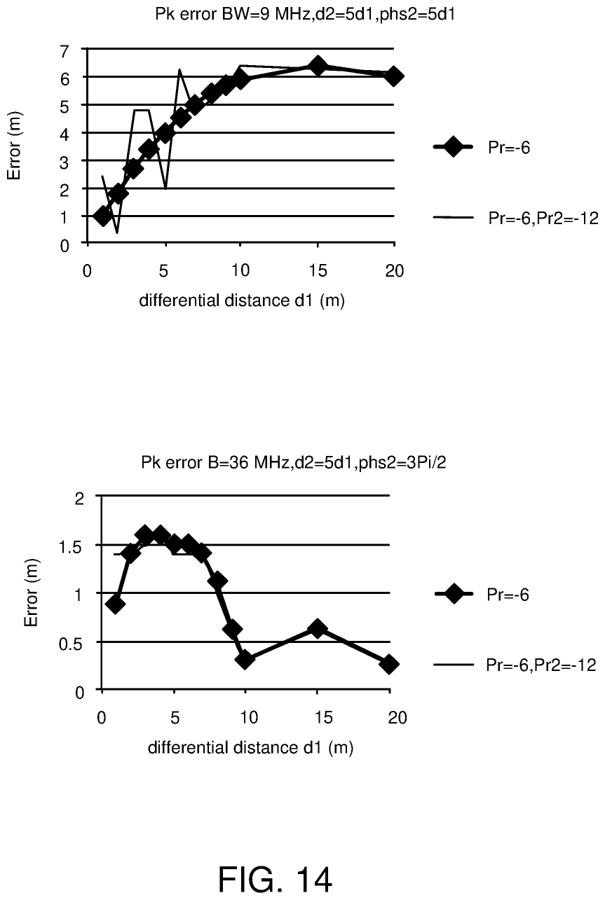

Ranging error is also reduced in the presence of more than one multipath signal as illustrated in FIG. 14.

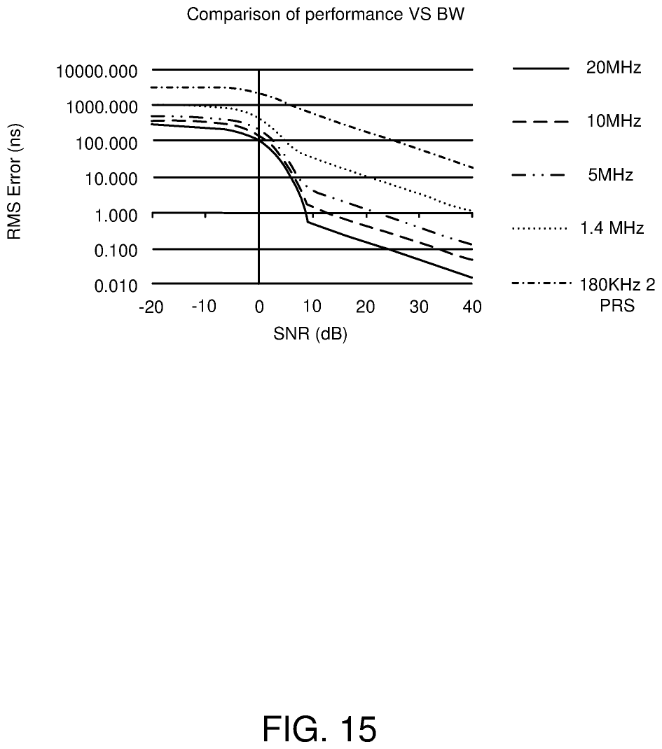

A further way to increases accuracy at a given SNR of an OFDM signal is fundamentally to increases the number of PRS elements. Thus a wider bandwidth 4G LTE channel will have more PRSs than a narrow band 4G LTE channel and will have greater sensitivity. This is seen in FIG. 15 using the linear regression method.

Since performance is stated as a function of the SNR per bandwidth or subcarrier, if the number of PRSs increases in any bandwidth, the performance will also increase. The present PRS configuration of 4G LTE signals is one PRS element per 6 frequency elements as seen in FIG. 1. However, it is possible to use other reference signals such as the SRS (secondary reference signals) and others, which will increase the performance. The optimum solution is to use all the frequency elements as PRSs, which can be simulated by setting all the elements to be PRSs.

At a certain SNR the probability of making a symbol error, akin to a bit error, is very low. At this point the symbol decisions have been made and are correct to a high degree. These symbol decisions can then be used as reference signals or PRS equivalents since these symbols may now be deemed known to a high degree of confidence. These then are compared to actual analog I,Q input symbols to determine the phase. This technique is known as decision feedback.

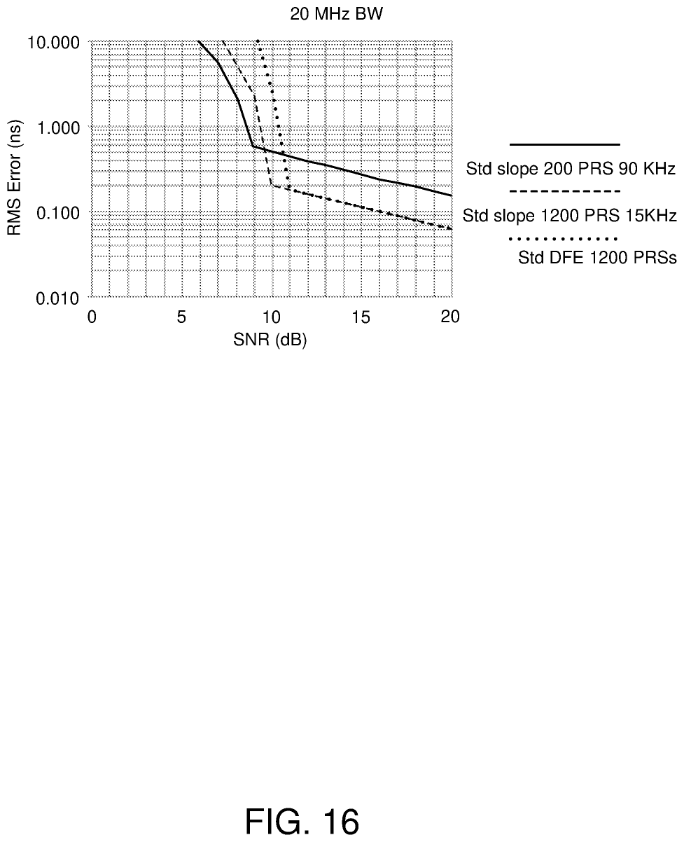

In turn, in one approach, a system switches to decision feedback once the SNR of the OFDM signal is sufficiently high, and hence the probability of symbol error, is sufficiently low. FIG. 16 illustrates the performance with current PRSs, all elements set as PRSs and if decision feedback is used. As such, if the SNR is less than a first threshold, the system uses standard configuration of PRS and if the SNR exceeds a second threshold, the system switches to decision feedback.

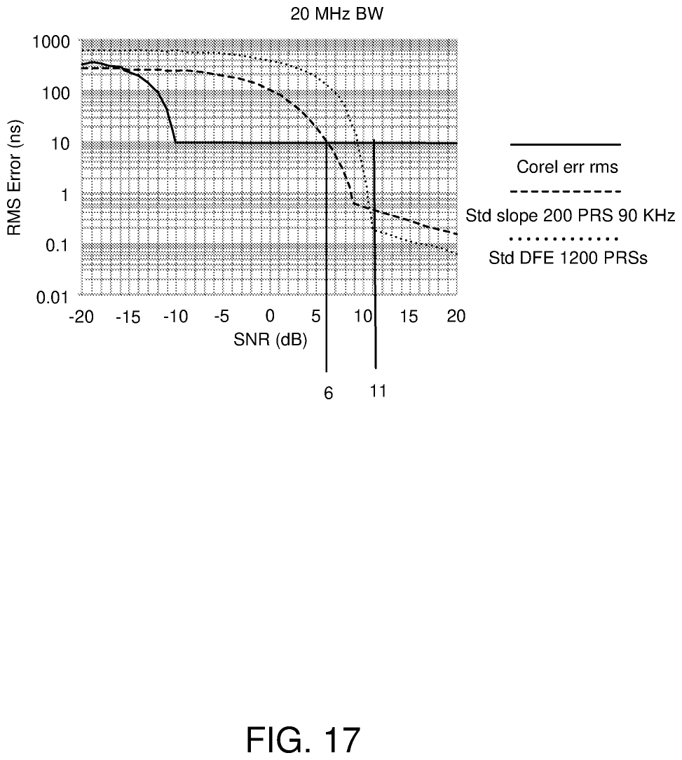

This threshold idea can be extended to also consider the typical correlation approach as seen in FIG. 17. When used two thresholds establish three portions in which when SNR is less than the first threshold, the system uses a correlation method for range estimate, when the SNR is between the first and second threshold, standard PRSs are used in the group delay method, and when the SNR exceeds the second threshold, the system uses decision feedback.

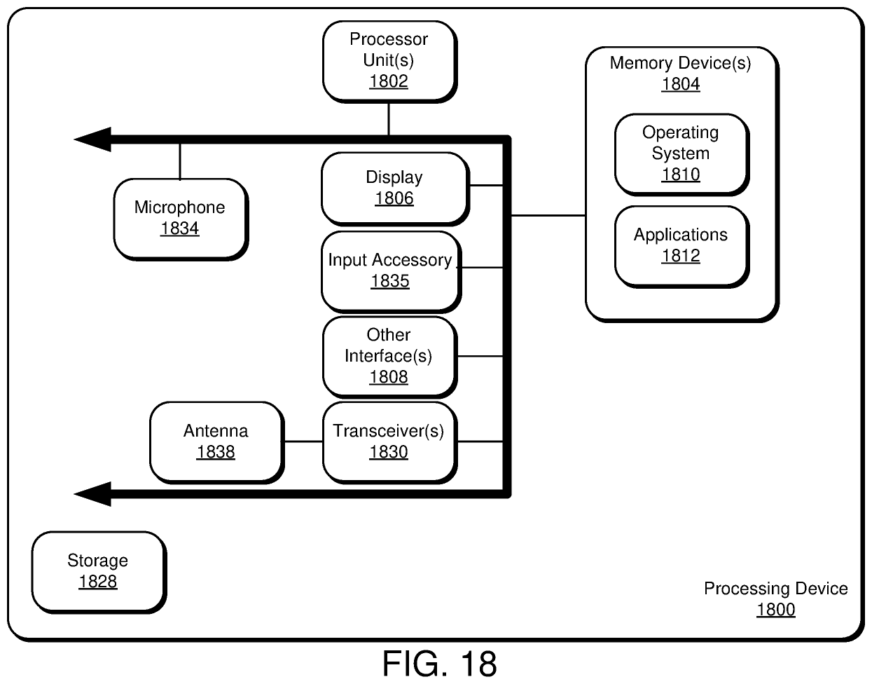

FIG. 18 illustrates an example schematic of a processing device 1800 suitable for implementing aspects of the disclosed technology. For instance the processing device 1800 may include or execute the high precision processors described above and/or other elements of the disclosed technology. The processing device 1800 includes one or more processor unit(s) 1802, memory 1804, a display 1806, and other interfaces 1808 (e.g., buttons). The memory 1804 generally includes both volatile memory (e.g., RAM) and non-volatile memory (e.g., flash memory). An operating system 1810, such as the Microsoft Windows® operating system, the Microsoft Windows® Phone operating system or a specific operating system designed for a gaming device, resides in the memory 1804 and is executed by the processor unit(s) 1802, although it should be understood that other operating systems may be employed.

One or more applications 1812 are loaded in the memory 1804 and executed on the operating system 1810 by the processor unit(s) 1802. Applications 1812 may receive input from various input local devices such as a microphone 1834, input accessory 1835 (e.g., keypad, mouse, stylus, touchpad, gamepad, racing wheel, joystick). Additionally, the applications 1812 may receive input from one or more remote devices by communicating with such devices over a wired or wireless network using more communication transceivers 1830 and an antenna 1838 to provide network connectivity (e.g., a mobile phone network, Wi-Fi®, Bluetooth®). The processing device 1800 may also include various other components, such as a positioning system (e.g., a global positioning satellite transceiver), one or more accelerometers, one or more cameras, an audio interface (e.g., the microphone 1834, an audio amplifier and speaker and/or audio jack), and storage devices 1828. Other configurations may also be employed.

The processing device 1800 further includes a power supply 1816, which is powered by one or more batteries or other power sources and which provides power to other components of the processing device 1800. The power supply 1816 may also be connected to an external power source (not shown) that overrides or recharges the built-in batteries or other power sources.

In an example implementation, a high resolution positioning module as described above may include hardware and/or software embodied by instructions stored in the memory 1804 and/or the storage devices 1828 and processed by the processor unit(s) 1802. The memory 1804 may be the memory of a host device or of an accessory that couples to the host.

The processing system 800 may include a variety of tangible processor-readable storage media and intangible processor-readable communication signals. Tangible processor-readable storage can be embodied by any available media that can be accessed by the processing system 800 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing system 800. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

1. A method for ranging using orthogonal frequency division multiplexed (OFDM) signals, the method comprising:
receiving a first OFDM signal at a receiver at a first bandwidth;
measuring a signal power of each of a plurality of symbols of subcarriers for the first OFDM signal;
determining a signal anomaly in the first OFDM signal based on the signal power of each of the plurality of symbols in the first OFDM signal;
increasing the first bandwidth to a second bandwidth;
receiving a second OFDM signal at the second bandwidth;
calculating a range from a transmitter of the second OFDM signal to the receiver based on the second OFDM signal at the second bandwidth.

2. The method of claim 1, wherein the first OFDM signal and the second OFDM signal comprise at least one of 4G. 5G LTE, or WiFi signals.

3. The method of claim 1, wherein the first bandwidth comprises a first number of subcarriers being assigned to the receiver and the second bandwidth comprises a second number of sub-channels greater than the first number of subcarriers being assigned to the receiver.

4. The method of claim 1, wherein the signal anomaly comprises multipath signal propagation and the determining comprises:
measuring a difference between the highest measured signal power and the lowest measured signal power for the plurality of symbols and comparing the difference to a threshold flatness value.

5. The method of claim 1, wherein the plurality of symbols comprise positioning reference signals of the OFDM.

6. The method of claim 1, wherein the plurality of symbols comprise positioning reference signals and at least one other symbol of the OFDM.

7. The method of claim 6, wherein the at least one other symbol of the OFDM comprises a data symbol encoding transmitted data from the transmitter to the receiver.

8. The method of claim 1, further comprising:
measuring a signal power of each of a plurality of symbols of subcarriers for the second OFDM signal;
determining a slope corresponding to the difference in phase of the plurality of symbols of subcarriers for the second OFDM signal relative to frequency of the OFDM signal; and
calculating a transmission delay based on the slope that is used to determine the range.

9. A method for ranging using orthogonal frequency division multiplexed (OFDM) signals, the method comprising:
receiving at a receiver a first OFDM signal having a first signal to noise ratio (SNR);
determining a first number of reference symbols to use to determine a first range between a transmitter of the first OFDM signal and the receiver;
receiving at the receiver a second OFDM signal having a second SNR that is greater than the first SNR;
determining a second number of reference symbols to use to determine a second range between a transmitter of the second OFDM signal and the receiver, wherein the second number of reference symbols is greater than the first number of reference symbols.

10. The method of claim 9, wherein the first number of reference symbols comprises a single position reference signal (PRS) of the first OFDM signal and the first range is determined using an observed time difference of arrival correlation method relative to the single PRS.

11. The method of claim 9, wherein the second number of reference symbols comprises a plurality of PRSs and the second range is determined using a calculated slope of the phase differences of the plurality of PRSs.

12. The method of claim 9, further comprising:
receiving at the receiver a third OFDM signal having a third SNR that is greater than the second SNR; and
determining a third number of reference symbols to use in relation to determine a third range between a transmitter of the third OFDM signal and the receiver, wherein the third number of reference symbols is greater than the second number of reference symbols.

13. The method of claim 12, wherein the third number of reference symbols comprise a plurality of PRSs and at least one other symbol of the third OFDM signal and the third range is determined using a decision feedback approach.

14. The method of claim 13, wherein the at least one other symbol of the OFDM signal comprises a data symbol encoding transmitted data from the transmitter to the receiver.

15. A method for ranging using orthogonal frequency division multiplexed (OFDM) signals, comprising:
first receiving a first OFDM signal having at least one positioning reference signal (PRS);
determining a coarse time reference using an observed time difference of arrival (OTDOA) correlation applied to the first OFDM signal;
second receiving a second OFDM signal having a plurality of positioning reference signals;
determining a phase slope of the plurality of positioning reference signals (PRSs) relative to frequency based on the coarse time reference; and
calculating a fine time reference having an accuracy greater than the coarse time reference using the phase slope of the plurality of PRSs.
